(19) United States
(12) Patent Application Publication
(10) Pub. No.: US 2008/0254234 A1
(43) Pub. Date: Oct. 16, 2008

(54) RADIATION-HARDENED COATINGS WITH IMPROVED ADHESIVE STRENGTH

(75) Inventors: Ralf Fink, Schifferstadt (DE); Wolfgang Paulus, Mainz (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 12/143,431

(22) Filed: Jun. 20, 2008

Related U.S. Application Data
(63) Continuation of application No. 10/501,072, filed on Jul. 9, 2004.

(30) Foreign Application Priority Data
Jan. 15, 2002 (DE) 102 01 420.5

(51) Int. Cl. C08F 20/06; B05D 3/06

(52) U.S. Cl. 427/595; 526/317.1; 526/301; 526/314

(57) ABSTRACT

Mixtures comprising at least one radiation-curable composition (I) and at least one pressure-sensitive adhesive (II).

The present invention relates to radiation-curable coatings whose adhesion is improved by incorporating adhesives.

Radiation-curable coating materials based on acrylic resins are known and are often used for coatings on substrates such as metals or plastics moldings. The polymerization shrinkage which occurs in the course of radiation curing of the coating film applied to the substrate has an adverse effect on the adhesion of the coating to the substrate.

It is known to improve the adhesion of the radiation-curable coating film by raising the molar weight of the film-forming resins, reducing their double-bond density, or adding nonreactive polymers. This, however, leads to an unwanted increase in the viscosity of the coating materials.

EP-A 1 072 658 discloses radiation-curable, amine-modified acrylic resins whose adhesion is improved by admixing amine-curable polyepoxide compounds having a molar weight of less than 2000 g/mol.

One disadvantage here is that the concept described in EP-A 1 072 658 can only be applied to amine compounds.

There nevertheless continues to be a need for radiation-curable coating materials which possess good adhesion to glass, metal or plastics substrates.

It is an object of the present invention to develop radiation-curable coatings with greater adhesion.

We have found that this object is achieved by mixtures comprising at least one radiation-curable composition (I) and at least one pressure sensitive adhesive (II).

The radiation-curable compositions (I) which can be used in accordance with the invention are known per se and are not restricted. They generally contain at least one free-radically and/or cationically polymerizable group.

Polymerizable groups can be groups which contain unsaturated bonds, preferably carbon-carbon double bonds.

Examples of free-radically polymerizable groups include isolated ethylenically unsaturated groups, conjugated unsaturated groups, vinylaromatic groups, vinyl chloride and vinylidene chloride groups, N-vinyl amides, vinylpyrrolidones, vinyllactams, vinyl esters, (meth)acrylic esters, and acrylonitriles.

Examples of cationically polymerizable groups include isobutylene units or vinyl ethers.

The preferred radiation-curable compositions (I) include as their polymerizable groups preferably acrylate, methacrylate or vinyl ether functions.

A radiation-curable composition (I) which can be used in accordance with the invention customarily comprises
(A) at least one polymerizable compound containing two or more copolymerizable, ethylenically unsaturated groups,
(B) if desired, reactive diluents,
(C) if desired, photoinitiator and
(D) if desired, further, typical coatings additives.

Suitable compounds (A) include radiation-curable, free-radically polymerizable compounds containing two or more, i.e. at least two, copolymerizable, ethylenically unsaturated groups.

Compounds (A) are preferably vinyl ether or (meth)acrylate compounds, with particular preference being given in each case to the acrylate compounds, i.e., the derivatives of acrylic acid.

Preferred vinyl ether and (meth)acrylate compounds (A) contain from 2 to 20, preferably from 2 to 10, and with very particular preference from 2 to 6 copolymerizable, ethylenically unsaturated double bonds.

Particular preference is given to compounds (A) having an ethylenically unsaturated double bond content of 0.1-0.7 mol/100 g, with very particular preference 0.2-0.6 mol/100 g.

Unless stated otherwise, the number-average molecular weight Mₙ of the compounds (A) is preferably below 15 000, with particular preference 300-12 000, with very particular preference 400-5000, and in particular 500-3000 g/mol (as determined by gel permeation chromatography using polystyrene standards and tetrahydrofuran eluent).

(Meth)acrylate compounds that may be mentioned include (meth)acrylic esters and especially acrylic esters and vinyl ethers of polyfunctional alcohols, especially those which beside the hydroxyl groups contain no further functional groups or only ether groups. Examples of such alcohols include difunctional alcohols, such as ethylene glycol, propylene glycol, and their counterparts with higher degrees of condensation, such as diethylene glycol, triethylene glycol, dipropylene glycol, tripropylene glycol, etc., 1,2-, 1,3- or 1,4-butanediol, 1,5-pentanediol, 1,6-hexanediol, 3-methyl-1,5-pentanediol, neopentyl glycol, alkoxylated phenolic compounds, such as ethoxylated and/or propoxylated bisphenols, 1,2-, 1,3- or 1,4-cyclohexanedimethanol, alcohols with a functionality of three or more, such as glycerol, trimethylolpropane, butanetriol, trimethylolethane, pentaerythritol, ditrimethylolpropane, dipentaerythritol, sorbitol, mannitol, and the corresponding alkoxylated, especially ethoxylated and/or propoxylated, alcohols.

The alkoxylation products are obtainable conventionally by reacting the above alcohols with alkylene oxides, especially ethylene oxide or propylene oxide. The degree of alkoxylation per hydroxyl group is preferably from 0 to 10; that is, 1 mol of hydroxyl group may have been alkoxylated with up to 10 mol of alkylene oxides.

(Meth)acrylate compounds that may be mentioned further include polyester (meth)acrylates, which are the (meth)acrylic esters or vinyl ethers of polyesterols.

Examples of suitable polyesterols include those which can be prepared by esterifying polycarboxylic acids, preferably dicarboxylic acids, with polyols, preferably diols. Starting materials for such hydroxyl-containing polyesters are known to the skilled worker. Dicarboxylic acids which can be used preferably include succinic acid, glutaric acid, adipic acid, sebacic acid, o-phthalic acid, tetrahydrophthalic acid, terephthalic acid, their isomers and hydrogenation products, and esterifiable derivatives, such as anhydrides or dialkyl esters of said acids. Suitable polyols include the abovementioned alcohols, preferably ethylene glycol, propylene 1,2-glycol and 1,3-glycol, butane-1,4-diol, hexane-1,6-diol, neopentyl glycol, cyclohexanedimethanol, and polyglycols of the ethylene glycol and propylene glycol type.

Examples of suitable radiation-curable compounds (A) also include unsaturated polyester resins, which consist essentially of polyols, especially diols, and polycarboxylic acids, especially dicarboxylic acids, one of the esterification components containing a copolymerizable, ethylenically unsaturated group. Said component is for example maleic acid, fumaric acid or maleic anhydride.

Polyester (meth)acrylates can be prepared in a plurality of stages or else in one stage, as described in EP-A 279 303 for example, from (meth)acrylic acid, polycarboxylic acid, and polyol.

Additionally, compounds (A) may comprise, for example, urethane or epoxy (meth)acrylates or urethane or epoxy vinyl ethers.

Urethane (meth)acrylates, for example, are obtainable by reacting polyisocyanates with hydroxyalkyl (meth)acrylates or hydroxylalkyl vinyl ethers and, where appropriate, chain extenders such as diols, polyols, diamines, polyamines or dithiols or polythiols. Urethane (meth)acrylates which can be dispersed in water without adding emulsifiers further contain ionic and/or nonionic hydrophilic groups, which are introduced into the urethane by means, for example, of synthesis components such as hydroxy carboxylic acids.

The polyurethanes which can be used in accordance with the invention as (A) include as synthesis components substantially:
a) at least one organic aliphatic, aromatic or cycloaliphatic di- or polyisocyanate,
b) at least one compound containing at least one isocyanate-reactive group and at least one free-radically polymerizable unsaturated group and/or one cationically polymerizable group,
c) if desired, at least one compound containing at least one isocyanate-reactive group and at least one actively dispersing group,
d) if desired, at least one compound containing at least two isocyanate-reactive groups, and
e) if desired, compounds other than a) to c) containing at least one isocyanate-reactive group.

Examples of suitable components a) include aliphatic, aromatic, and cycloaliphatic di- and polyisocyanates having an NCO functionality of at least 1.8, preferably from 1.8 to 5, and with particular preference from 2 to 4, and also their isocyanurates, biurets, allophanates, and uretdiones.

The diisocyanates are preferably isocyanates having from 4 to 20 carbon atoms. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane(isophorone diisocyanate), 1,3- or 1,4-bis(isocyanatomethyl)cyclohexane or 2,4-, or 2,6-diisocyanato-1-methylcyclohexane, and aromatic diisocyanates such as 2,4- or 2,6-tolylene diisocyanate and isomer mixtures thereof, m- or p-xylylene diisocyanate, 2,4′- or 4,4′-diisocyanatodiphenylmethane and isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methylbiphenylmethane 4,4′-diisocyanate, tetramethylxylylene diisocyanate, 1,4-diisocyanatobenzene or diphenyl ether 4,4′-diisocyanate.

It is also possible for mixtures of said diisocyanates to be present.

Preference is given to hexamethylene diisocyanate, 1,3-bis(isocyanatomethyl)cyclohexane, isophorone diisocyanate and di(isocyanatocyclohexyl)methane.

Suitable polyisocyanates include polyisocyanates containing isocyanurate groups, uretdione diisocyanates, polyisocyanates containing biuret groups, polyisocyanates containing urethane or allophanate groups, polyisocyanates containing oxadiazinetrione groups, uretoneimine-modified polyisocyanates from linear or branched C₄-C₂₀ alkylene diisocyanates, cycloaliphatic diisocyanates having a total of from 6 to 20 carbon atoms or aromatic diisocyanates having a total of from 8 to 20 carbon atoms, or mixtures thereof.

The di- and polyisocyanates which can be used preferably have an isocyanate group content (calculated as NCO, molecular weight=42) of from 10 to 60% by weight, based on the di- and polyisocyanate (mixture), more preferably from 15 to 60% by weight, and with particular preference from 20 to 55% by weight.

Preference is given to aliphatic and cycloaliphatic di- and polyisocyanates, e.g., the aliphatic and cycloaliphatic diisocyanates mentioned above, or mixtures thereof.

Further preferred are
1) Polyisocyanates containing isocyanurate groups, from aromatic, aliphatic and/or cycloaliphatic diisocyanates. Particular preference is given here to the corresponding aliphatic and/or cycloaliphatic isocyanato-isocyanurates and especially to those based on hexamethylene diisocyanate and isophorone diisocyanate. The present isocyanurates are, in particular, trisisocyanatoalkyl or trisisocyanatocycloalkyl isocyanurates, which are cyclic trimers of the diisocyanates, or mixtures with their higher homologs containing more than one isocyanurate ring. The isocyanato-isocyanurates generally have an NCO content of from 10 to 30% by weight, in particular from 15 to 25% by weight, and an average NCO functionality of from 3 to 4.5.
2) Uretdione diisocyanates containing aromatically, aliphatically and/or cycloaliphatically attached isocyanate groups, preferably aliphatically and/or cycloaliphatically attached groups, and especially those derived from hexamethylene diisocyanate or isophorone diisocyanate. Uretdione diisocyanates are cyclic dimerization products of diisocyanates. In the formulations of the invention the uretdione diisocyanates can be used as a sole component or in a mixture with other polyisocyanates, especially those specified under 1).
3) Polyisocyanates containing biuret groups and aromatically, cycloaliphatically or aliphatically attached, preferably cycloaliphatically or aliphatically attached, isocyanate groups, especially tris(6-isocyanatohexyl)biuret or its mixtures with its higher homologs. These biuret-containing polyisocyanates generally have an NCO content of from 18 to 22% by weight and an average NCO functionality of from 3 to 4.5.
4) Polyisocyanates containing urethane and/or allophanate groups and aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with polyhydric alcohols such as trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof, for example. These polyisocyanates containing urethanes and/or allophanate groups generally have an NCO content of from 12 to 20% by weight and an average NCO functionality of from 2.5 to 3.
5) Polyisocyanates containing oxadiazinetrione groups, preferably derived from hexamethylene diisocyanate or isophorone diisocyanate. Polyisocyanates of this kind containing oxadiazinetrione groups can be prepared from diisocyanate and carbon dioxide.
6) Uretoneimine-modified polyisocyanates.

The polyisocyanates 1) to 6) can be used in a mixture, including where appropriate a mixture with diisocyanates.

Suitable components b) include compounds which carry at least one isocyanate-reactive group and at least one free-radically or cationically polymerizable group.

Examples of possible iocyanate-reactive groups include —OH, —SH, —NH₂, and —NHR⁴, where R⁴ is hydrogen or an alkyl group containing from 1 to 4 carbon atoms, such as methyl, ethyl, n-propyl, iso-propyl, n-butyl, iso-butyl, sec-butyl or tert-butyl.

Possible polymerizable groups include groups containing unsaturated bonds, preferably carbon-carbon double bonds.

Examples of free-radically polymerizable groups are isolated ethylenically unsaturated groups, conjugated unsaturated groups, vinyl aromatic groups, vinyl chloride and vinylidene chloride groups, N-vinyl amides, vinylpyrrolidones, vinyllactams, vinyl esters, (meth)acrylic esters and acrylonitriles.

Examples of cationically polymerizable groups are isobutylene units and vinyl ethers.

Components b) can be, for example, monoesters of α,β-unsaturated carboxylic acids, such as acrylic acid, methacrylic acid (referred to below for short as “(meth)acrylic acid”), crotonic acid, itaconic acid, fumaric acid, maleic acid, acrylamidoglycolic acid, methacrylamido glycolic acid or vinyl ethers with diols or polyols which preferably have from 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, neopentyl glycol hydroxypivalate, 1,6-hexanediol, 2-methyl-1,5-pentanediol, 2-ethyl-1,4-butanediol, 1,4-dimethylolcyclohexane, glycerol, trimethylolethane, trimethylolpropane, trimethylolbutane, pentaerythritol, ditrimethylolpropane, erythritol, sorbitol, polyTHF having a molar weight of between 162 and 2000, poly-1,3-propanediol having a molar weight of between 134 and 400 or polyethylene glycol having a molar weight of between 238 and 458. Moreover, it is also possible to use esters or amides of (meth)acrylic acid with amino alcohols, e.g., 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine, or vinylacetic acid.

Also suitable, furthermore, are unsaturated polyetherols or polyesterols or polyacrylatepolyols having an average OH functionality of from 2 to 10.

Examples of amides of ethylenically unsaturated carboxylic acids with amino alcohols are hydroxyalkyl(meth)acrylamides such as N-hydroxymethylacrylamide, N-hydroxymethylmethacrylamide, N-hydroxyethylacrylamide, N-hydroxyethylmethacrylamide, 5-hydroxy-3-oxapentyl(meth)acrylamide, N-hydroxyalkylcrotonamides such as N-hydroxymethylcrotonamide or N-hydroxyalkylmaleimides such as N-hydroxyethylmaleimide.

Preference is given to using 2-hydroxyethyl(meth)acrylate, 2- or 3-hydroxypropyl(meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol mono- and di(meth)acrylate, trimethylolpropane mono- and di(meth)acrylate, pentaerythritol mono-, di- and tri(meth)acrylate, and also 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide. Particular preference is given to 2-hydroxyethyl acrylate, 2-hydroxyethyl methacrylate, 2- or 3-hydroxypropyl acrylate, 1,4-butanediol monoacrylate, and 3-(acryloyloxy)-2-hydroxypropyl methacrylate.

Suitable components c) include compounds containing at least one isocyanate-reactive group and at least one actively dispersing group.

Such compounds are represented for example by the formula

RG-R²-DG,

where
RG denotes at least one isocyanate-reactive group,
DG denotes at least one actively dispersing group, and
R² denotes an aliphatic, cycloaliphatic or aromatic radical containing from 1 to 20 carbon atoms.

Examples of RG are —OH, —SH, —NH₂, and —NHR⁴, in which R⁴ is as defined above but may be different than the radical used there.

Examples of DG are —COOH, —SO₃H, and —PO₃H and their anionic forms, with which any desired counterion may be associated, e.g., Li⁺, Na⁺, K⁺, Cs⁺, Mg²⁺, Ca²⁺, Ba²⁺, ammonium, methylammonium, dimethylammonium, trimethylammonium, ethylammonium, diethylammonium, triethylammonium, tributylammonium, di-iso-propylethylammonium, benzyldimethylammonium, monoethanolammonium, diethanolammonium, triethanolammonium, hydroxyethyldimethylammonium, hydroxyethyldiethylammonium, monopropanolammonium, dipropanolammonium, tripropanolammonium, piperidinium, piperazinium, N,N′-dimethylpiperazinium, morpholinium, and pyridinium.

R² can be, for example, methylene, 1,2-ethylene, 1,2-propylene, 1,3-propylene, 1,2-butylene, 1,4-butylene, 1,3-butylene, 1,6-hexylene, 1,8-octylene, 1,12-dodecylene, 1,2-phenylene, 1,3-phenylene, 1,4-phenylene, 1,2-naphthylene, 1,3-naphthylene, 1,4-naphthylene, 1,6-naphthylene, 1,2-cyclopentylene, 1,3-cyclopentylene, 1,2-cyclohexylene, 1,3-cyclohexylene or 1,4-cyclohexylene.

Component c) preferably comprises, for example, mercaptoacetic acid, mercaptopropionic acid, thiolactic acid, mercaptosuccinic acid, glycine, iminodiacetic acid, sarcosine, alanine, β-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, and their alkali metal, alkaline earth metal or ammonium salts, and with particular preference the aforementioned monohydroxycarboxylic and monohydroxysulfonic acids and also monoaminocarboxylic and monoaminosulfonic acids.

For preparing a dispersion the aforementioned acids, where they are not already salts, are fully or partly neutralized, preferably with alkali metal salts or amines, preferably tertiary amines.

Suitable components d) include compounds which carry at least two isocyanate-reactive groups, examples being —OH, —SH, —NH₂, and —NHR⁵, in which R⁵ is hydrogen or an alkyl group containing from 1 to 4 carbon atoms, such as methyl, ethyl, n-propyl, iso-propyl, n-butyl, iso-butyl, sec-butyl or tert-butyl, for example.

These compounds are preferably diols or polyols, such as hydrocarbon diols containing from 2 to 20 carbon atoms, e.g., ethylene glycol, 1,2-propanediol, 1,3-propanediol, 1,1-dimethylethane-1,2-diol, 1,6-hexanediol, 1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalinediol, etc., esters thereof with short-chain dicarboxylic acids, such as adipic acid, cyclohexanedicarboxylic acid, their carbonates, prepared by reacting the diols with phosgene or by transesterification with dialkyl or diaryl carbonates, or aliphatic diamines, such as methylene- and isopropylidene-bis(cyclohexylamine), piperazine, 1,2-, 1,3- or 1,4-diaminocyclohexane, 1,2-, 1,3- or 1,4-cyclohexanebis(methylamine), etc., dithiols or polyfunctional alcohols, secondary or primary amino alcohols, such as ethanolamine, diethanolamine, monopropanolamine, dipropanolamine, etc. or thio alcohols, such as thioethylene glycol.

Further possibilities include diethylene glycol, triethylene glycol, dipropylene glycol, tripropylene glycol, neopentyl glycol, pentaerythritol, 1,2- and 1,4-butanediol, 1,5-pentanediol, 2-methyl-1,5-pentanediol, 2-ethyl-1,4-butanediol, 1,2-, 1,3-, and 1,4-dimethylolcyclohexane, glycerol, trimethylolethane, trimethylolpropane, trimethylolbutane, dipentaerythritol, ditrimethylolpropane, erythritol, and sorbitol, 2-aminoethanol, 3-amino-1-propanol, 1-amino-2-propanol or 2-(2-aminoethoxy)ethanol, bisphenol A, or butanetriol.

Also suitable, furthermore, are unsaturated polyetherols or polyesterols or polyacrylatepolyols having an average OH functionality of from 2 to 10, and also polyamines, such as polyethyleneimine or polymers of, for example, poly-N-vinylformamide which contain free amine groups.

Particularly suitable here are the cycloaliphatic diols, such as bis(4-hydroxycyclohexane)isopropylidene, tetramethylcyclobutanediol, 1,2-, 1,3- or 1,4-cyclohexanediol, cyclooctanediol or norbornanediol, for example.

Suitable components e) include compounds containing at least one isocyanate-reactive group. They can be, for example, monoalcohols, mercaptans or monoamines containing from 1 to 20 carbon atoms, examples being methanol, ethanol, iso-propanol, n-propanol, n-butanol, iso-butanol, sec-butanol, tert-butanol, ethylene glycol monomethyl ether, ethylene glycol monoethyl ether, diethylene glycol monomethyl ether, diethylene glycol monoethyl ether, 1,3-propanediol monomethyl ether, 1,2-propanediol monoethyl ether, 1,2-propanediol monomethyl ether, n-hexanol, n-heptanol, n-octanol, n-decanol, n-dodecanol, 2-ethylhexanol, cyclopentanol, cyclohexanol, cyclooctanol, cyclododecanol, triethylene glycol monomethyl ether, triethylene glycol monoethyl ether, n-pentanol, stearyl alcohol, cetyl alcohol, lauryl alcohol, cyclopent-2-en-1-ol, cyclopent-3-en-1-ol, cyclohex-2-en-1-ol, allyl alcohol, methylamine, ethylamine, iso-propylamine, n-propylamine, n-butylamine, iso-butylamine, sec-butylamine, tert-butylamine, n-pentylamine, n-hexylamine, n-heptylamine, n-octylamine, n-decylamine, n-dodecylamine, 2-ethylhexylamine, stearylamine, cetylamine, laurylamine, dimethylamine, diethylamine, di-n-propylamine, di-iso-propylamine, di-n-butylamine, dihexylamine, dioctylamine, ethylmethylamine, iso-propylmethylamine, n-butylmethylamine, tert-butylmethylamine, iso-propylethylamine, n-butylethylamine, tert-butylethylamine, cyclopentylamine, cyclohexylamine, cyclooctylamine, cyclododecylamine, morpholine, piperidine, pyrrolidine, N-methylpiperazine, monoethanolamine, diethanolamine, monopropanolamine, dipropanolamine, methanethiol, ethanethiol, iso-propanethiol, n-propanethiol, n-butanethiol, iso-butanethiol, sec-butanethiol or tert-butanethiol.

The polyurethanes which can be used in accordance with the invention as (A) are obtained by reacting components a) and b) with one another.

In this reaction the molar composition a):b) per 3 mole of reactive isocyanate groups in a) is generally as follows:

b) 0.1-3.0, preferably 0.5-2.8, with particular preference 1.0-2.5, and in particular 1.5-2.5 mol of isocyanate-reactive groups,
c) 0-30 mol %, preferably 2-20 mol %, with particular preference 3-15%, and in particular 5-10 mol % of isocyanate-reactive groups still present following reaction with b),
d) 0-50 mol %, preferably 5-40 mol %, with particular preference 10-30 mol %, and in particular 15-25 mol % of isocyanate-reactive groups still present following reaction with b), and
e) 0-50 mol %, preferably 5-40 mol %, with particular preference 10-30 mol %, and in particular 15-25 mol % of isocyanate-reactive groups still present following reaction with b).

Following reaction of the components a) and b), and also where appropriate c), d), and e), the polyurethane (A) may still contain free isocyanate groups; preferably, however, more than 70% of the isocyanate groups present prior to the reaction in a) have been reacted, with particular preference more than 80%, with very particular preference more than 90%, and in particular more than 95%.

When the polyurethanes are used in aqueous systems, it is preferable for substantially all of the isocyanate groups present to have been reacted.

The formation of the adduct of isocyanate-functional compound and the compound containing isocyanate-reactive groups takes place generally by mixing of the components in any desired sequence, where appropriate at an elevated temperature.

In this mixing operation, the compound containing isocyanate-reactive groups is preferably added to the compound containing isocyanate groups, more preferably in two or more steps.

With particular preference, the compound containing isocyanate groups is introduced initially and the compounds containing isocyanate-reactive groups are added. In particular, the isocyanate-functional compound a) is introduced initially and then b) is added. After that, where appropriate, further desired components can be added.

The reaction is generally conducted at temperatures between 5 and 100° C., preferably between 20 and 90° C., and with particular preference between 40 and 80° C., and in particular between 60 and 80° C.

It is preferred to operate under water-free conditions.

Water-free means that the amount of water in the reaction system is not more than 5% by weight, preferably not more than 3% by weight, and with particular preference not more than 1% by weight.

The reaction is preferably conducted in the presence of at least one suitable inert gas, examples being nitrogen, argon, helium, carbon dioxide or the like.

The reaction may also be conducted in the presence of an inert solvent, such as acetone, iso-butyl methyl ketone, toluene, xylene, butyl acetate or ethoxyethyl acetate, but is preferably conducted in the absence of a solvent.

The urethane (meth)acrylates preferably have a number-average molar weight Mₙ of from 500 to 20 000, in particular from 750 to 10 000, and with particular preference from 750 to 3000 g/mol (as determined by gel permeation chromatography using tetrahydrofuran and polystyrene as standard).

The urethane (meth)acrylates preferably contain from 1 to 5 mol, with particular preference from 2 to 4 mol, of (meth)acrylic groups per 1000 g of urethane (meth)acrylate.

The urethane vinyl ethers preferably contain from 1 to 5 mol, with particular preference from 2 to 4 mol, of vinyl ether groups per 1000 g of urethane vinyl ether.

Epoxy (meth)acrylates are obtainable by reacting epoxides with (meth)acrylic acid. Vinyl ether epoxides are obtainable by reacting epoxides of hydroxyalkyl vinyl ethers. Examples of suitable epoxides include epoxidized olefins and glycidyl ethers, e.g., bisphenol A diglycidyl ether or aliphatic glycidyl ethers, such as butanediol diglycidyl ether.

The epoxy (meth)acrylates and epoxy vinyl ethers preferably have a number-average molar weight Mₙ of from 500 to 20 000, with particular preference from 750 to 10 000 g/mol, and with very particular preference from 750 to 3000 g/mol; the amount of (meth)acrylic groups or vinyl ether groups is preferably from 1 to 5, with particular preference from 2 to 4, per 1000 g of epoxy (meth)acrylate or vinyl ether epoxide (as determined by gel permeation chromatography using polystyrene standards and tetrahydrofuran eluent).

Radiation-curable compounds (A) which are further suitable include carbonate (meth)acrylates, containing on average preferably from 1 to 5, in particular from 2 to 4, with particular preference from 2 to 3, and with very particular preference 2 (meth)acrylic groups.

The number-average molecular weight Mₙ of the carbonate (meth)acrylates is preferably less than 3000 g/mol, with particular preference less than 1500 g/mol, with very particular preference less than 800 g/mol (as determined by gel permeation chromatography using polystyrene as standard and tetrahydrofuran as solvent).

The carbonate (meth)acrylates are obtainable in a simple way by transesterification of carbonic esters with polyhydric, preferably dihydric, alcohols (diols, e.g. hexanediol) and subsequent esterification of the free OH groups with (meth)acrylic acid or else transesterification with (meth)acrylic esters, as described for example in EP-A 92 269. They can also be obtained by reacting phosgene, urea derivatives with polyhydric, e.g. dihydric, alcohols.

In an analogous way, vinyl ether carbonates are also obtainable by reacting a hydroxyalkyl vinyl ether with carbonic esters and also, if desired, dihydric alcohols.

Also possible are (meth)acrylates or vinyl ethers of polycarbonatepolyols, such as the reaction product of one of the diols or polyols mentioned and a carbonic ester and also a hydroxyl-containing (meth)acrylate or vinyl ether.

Examples of suitable carbonic esters are ethylene carbonate, 1,2- or 1,3-propylene carbonate, dimethyl, diethyl or dibutyl carbonate.

Examples of suitable hydroxy-containing (meth)acrylates are 2-hydroxyethyl (meth)acrylate, 2- or 3-hydroxypropyl (meth)acrylate, 1,4-butanediol mono(meth)acrylate, neopentyl glycol mono(meth)acrylate, glycerol mono- and di(meth)acrylate, trimethylolpropane mono- and di(meth)acrylate, and pentaerythritol mono-, di- and tri(meth)acrylate.

Examples of suitable hydroxy-containing vinyl ethers are 2-hydroxyethyl vinyl ether and 4-hydroxybutyl vinyl ether.

Particularly preferred carbonate (meth)acrylates are those of the formula:

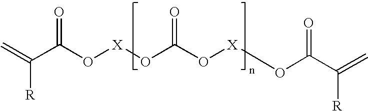

where R is H or CH₃, X is a C₂-C₁₈ alkylene group, and n is an integer from 1 to 5, preferably from 1 to 3.

R is preferably H and X is preferably C₂ to C₁₀ alkylene, such as 1,2-ethylene, 1,2-propylene, 1,3-propylene, 1,4-butylene or 1,6-hexylene, with particular preference C₄ to C₈ alkylene. With very particular preference, X is C₆ alkylene.

The compounds are preferably aliphatic carbonate (meth)acrylates.

As radiation-curable compounds (A) it is also possible, moreover, to use (meth)acrylates or vinyl ethers of polyetherpolyols. These may be monohydric or preferably polyhydric polyether alcohols containing on average from 2 to 70, preferably from 2 to 60, polyalkylene oxide units per molecule, as obtainable conventionally by alkoxylating suitable starter molecules. For preparing these polyether alcohols it is possible to use any desired monohydric or polyhydric alcohols as starter molecules.

Alkylene oxides suitable for the alkoxylation are ethylene oxide, propylene oxide, butylene oxide, iso-butylene oxide, and vinyloxirane, which can be used in any desired sequence or else as a mixture for the alkoxylation reaction.

Examples of suitable starter molecules include trimethylolpropane, trimethylolethane, neopentyl glycol, neopentyl glycol hydroxypivalate, pentaerythritol, glycerol, ditrimethylolpropane, dipentaerythritol, sorbitol, mannitol, diglycerol, 1,2-propanediol, ethylene glycol, 2,2-dimethyl-1,2-ethanediol, neopentyl glycol, 1,3-propanediol, 1,2-butanediol or 1,4-butanediol.

Polyether alcohols containing vinyl ether groups are obtained, for example, by reacting hydroxyalkyl vinyl ethers with alkylene oxides.

Polyether alcohols containing (meth)acrylic acid groups can be obtained, for example, by transesterifying (meth)acrylic esters with the polyether alcohols, by esterifying the polyether alcohols with (meth)acrylic acid, or by using hydroxyl-containing (meth)acrylates as described above under b).

Preferred polyether alcohols are polyethylene glycols having a molar mass of between 106 and 2000, preferably between 106 and 898, with particular preference between 238 and 678.

As polyether alcohols it is also possible to use polyTHF having a molar mass of between 162 and 2000 and also poly-1,3-propanediol having a molar mass of between 134 and 1178.

As compounds (A) it is further possible, in accordance with the invention, to use free-radically crosslinkable copolymers which have been modified by a polymer-analogous reaction.

Such polymer-analogously modified, free-radically crosslinkable copolymers and processes for preparing them are described, for example, in DE-A 43 37 480, DE-A 43 37 481, DE-A 43 37 482 and WO 97/46594, and also DE-A 100 166 52 and DE-A 100 166 53.

Polymer-analogously modified copolymers which can be used in accordance with the invention may be prepared, for example, as follows in two steps.

First of all, in a copolymerization of the monomers (f1) to (f3), a copolymer (F) is prepared which carries reactive groups via which it can be reacted to give the modified copolymer in a subsequent polymer-analagous reaction. For this purpose, use is made as monomers (f1) and (f2) of monomers (f3) which in addition to the olefinic double bond carry additional reactive groups which are inert under the conditions of the copolymerization. In a second step, the copolymers (F) thus obtained are reacted with vinyl compounds (G) additionally containing further functionalities which react with the reactive groups of the copolymer (F) to form chemical bonds.

The number-average molecular weight Mₙ of the polymers of the invention is situated, for example, between 1500 and 10 000, preferably between 1500 and 6000, and with particular preference between 2000 and 4000.

The polydispersity M_{w}/Mₙ, the quotient formed from the number-average and the weight-average molecular weights of the copolymers, represents a measure of the molecular weight distribution of the copolymers and in an ideal case has the value 1, although values below 4.0, in particular below 3.5, are sufficient for practical purposes.

The figures for the polydispersity and for the number-average and weight-average molecular weights Mₙ and M_{w} respectively relate here to gel permeation chromatography measurements, for which polystyrene was used as standard and tetrahydrofuran as eluent. The method is described in Analytiker Taschenbuch, Vol. 4, pages 433 to 442, Berlin 1984.

The molecular weight and the molecular weight distribution of the copolymers of the invention are determined by the polymerization conditions when preparing the copolymers (F).

The formation of copolymers (F) of low polydispersity and low molecular weight is favored in particular when reaction temperatures of from 140 to 210° C., more preferably from 150 to 180° C., and with particular preference from 150 to 170° C. are chosen and when reaction times of from 2 to 90 minutes, preferably from 5 to 25 minutes, and with particular preference from 10 to 15 minutes are chosen.

Where monomers or solvents are used whose boiling points are below the reaction temperature, the reaction is appropriately conducted under pressure, preferably under the autogenous pressure of the system. Pressures higher than 30 bar are not generally necessary, however.

Such polymerization conditions may be realized in particular in an annular-gap thin-film reactor with recycle means, since here the exothermic polymerization can be carried out under substantially isothermal conditions, owing to the advantageous ratio of heat exchange area to reaction volume.

Copolymerizations in annular-gap thin-film reactors are described, for example, in DE-A 4 203 277 and DE-A 4 203 278. They are common knowledge and can be implemented, for example, in the form of a tube reactor equipped with a rotor, and are obtainable, for example, from Buss SMS GmbH Verfahrenstechnik. They are preferably equipped with an apparatus by means of which some of the product can be recycled to the reactor entry.

Other polymerization apparatus, e.g., stirred tanks, are likewise suitable provided sufficient heat dissipation is ensured.

The polymerization can be performed in the absence of solvent, although solution polymerization is generally preferred owing to the low viscosity of the resulting polymer solutions. The amount of the solvent is generally from 0 to 30% by weight, preferably from 10 to 25% by weight, based on the total amount of monomers used.

Suitable solvents are all liquids which are inert toward the reactants, thus including, for example, ethers such as ethylene glycol ethers and ethylene diglycol ethers, esters such as butyl acetate, and ketones such as methyl amyl ketone. With particular advantage, regulating solvents are used, such as alkylaromatics, e.g., toluene, xylenes, and especially cumene and m-xylene, and also aliphatic alcohols, e.g., isopropanol.

It is generally advisable to limit the conversion to 50 to 95 mol %, preferably 80 to 90 mol %, since in this way narrower molecular weight distributions are achieved. Unconverted monomers and also volatile oligomers and the solvent are separated conventionally from the polymer, by distillation, for example, and then appropriately recycled to the polymerization.

Particularly suitable polymerization initiators are those free-radical-forming compounds whose decomposition temperature is from 140 to 200° C., in other words, for example, di-tert-butyl peroxide and dibenzoyl peroxide.

The amount of the initiators is preferably from 0.5 to 10 mol %, with particular preference from 1 to 5 mol % of the total amount of monomers used.

Regarding the composition of the copolymers (F), it should be emphasized that, independently of the nature of the remaining part of the molecule, it is the relatively high proportion of the monomers (f1) containing the methacryloyl structural element (H₂C═C(CH₃)—(CO)—) of methacrylic acid that is important and that it is in principle irrelevant which monomer type, (f1) to (f2), the monomers (f3) with the functional groups belong to. The monomer type (f1) therefore includes monomers containing nonreactive radicals and those of the type (f3). Below, the first-mentioned monomers are described first of all, followed by the monomers (f3) containing the functional groups.

The monomers (f1) are primarily the C₁ to C₁₂ alkyl esters of methacrylic acid, examples being ethyl methacrylate, 2-ethylhexyl methacrylate and n-butyl methacrylate, and in particular methyl methacrylate.

Furthermore, methoxyethyl methacrylate, cyclohexyl methacrylate and benzyl methacrylate are suitable.

Suitable monomers (f2) include in principle all free-radically polymerizable monomers.

Of particular importance are the alkyl esters of acrylic acid. Examples of further highly suitable monomers of this kind are iso-, n- and tert-butyl acrylate.

Further suitable monomers, in addition to styrene and 1-methylstyrene, include, for example, 4-tert-butylstyrene and 2-chlorostyrene.

As further free-radically polymerizable monomers (f2), mention may be made of vinyl ethers of C₂ to C₂₀ fatty acids, such as especially vinyl acetate and vinyl propionate, vinyl halides such as vinyl chloride and vinylidene chloride, conjugated dienes such as butadiene and isoprene, vinyl ethers of C₁ to C₂₀ alkanols, e.g., vinyl iso-butyl ether, acrylonitrile, methacrylonitrile, and the C₁ to C₁₀ alkyl esters of crotonic acid and of maleic acid. Further suitable compounds include heterocyclic vinyl compounds such as 2-vinylpyridine and N-vinylpyrrolidone.

The monomers (f3), which may belong to each of classes (f1) and (f2), carry functional groups by means of which the desired functionalization of the copolymers (F) to give the copolymer of the invention in a condensation or addition reaction with a vinyl compound (G) carrying a complementary group may take place. Examples of such functional groups are the hydroxyl group, the carboxamido group, the amino group, the carbonyl group in aldehyde or ketone function, the isocyanate group, and in particular the carboxyl group and the epoxy group.

Corresponding monomers (f3) are primarily the relatively inexpensive compounds 2-hydroxyethyl acrylate and methacrylate, allyl alcohol, 2-aminoethyl acrylate and methacrylate, acrolein, methacrolein and vinyl ethyl ketone, acrylamide and methacrylamide, vinyl isocyanate, methacryloyl isocyanate, dimethyl-3-isopropenylbenzyl isocyanate (TMI) and 4-isocyanatostyrene, and especially acrylic acid, methacrylic acid, crotonic acid, maleic acid and their anhydrides, and also glycidyl acrylate and glycidyl methacrylate.

The polymers (F) are composed of from 50 to 85 mol %, preferably from 60 to 85 mol %, of one or more of the monomers (f1) and of from 15 to 50 mol %, preferably from 15 to 40 mol %, of one or more of the monomers (f2).

The fraction of one or more of the monomers (f3) as a proportion of the total amount of the monomers (f1) and (f2) is from 5 to 50 mol %, preferably from 15 to 40 mol %, with particular preference from 20 to 35 mol %.

At conversions of less than 100% the desired composition of the polymer (F) rarely corresponds to that of the monomer mixture used, because the monomers polymerize at different rates. In such cases it is necessary to adapt the fraction of the respective monomers in the monomer mixture according to their reaction rate. This adaptation may be made, for example, by analyzing the composition of the unconverted monomer mixture removed by distillation and so obtaining information about the composition of the copolymer (F). In principle it is necessary, for example, to choose a relatively high proportion of the methacrylic acid derivatives and to reduce the proportion of the other monomers.

Accordingly, the monomer mixtures usually contain from 60 to 95 mol %, preferably from 65 to 90 mol %, of one or more of the monomers (f1) and from 5 to 40 mol %, preferably from 10 to 35 mol %, of one or more of the monomers (f2).

The fraction of one or more of the monomers (f3) as a proportion of the total amount of the monomers (f1) and (f2) used is from 5 to 50 mol %, preferably from 15 to 40 mol %, with particular preference from 20 to 35 mol %.

Following their preparation, the copolymers (F) are preferably freed from the solvent and from excess monomers by distillation, for example, and the remaining small amounts of residual monomers and volatile oligomers are removed under reduced pressure or by passing nitrogen through the melt.

Owing to the high glass transition temperatures of the polymers and the high boiling points of some of the monomers, a continuously operated thin-film evaporator for example is especially suitable for this purpose, and in such an evaporator the copolymer is devolatilized preferably at temperatures from 180 to 220° C. above the polymerization temperature.

To give the free-radically crosslinkable modified polymers, the polymers (F) are derivatized in a polymer-analagous reaction. For this purpose they are reacted with those functional olefinically unsaturated monomers (G), referred to hereinafter as vinyl monomers (G), whose functional groups are complementary to those within the polymer.

Vinyl monomers (G) which carry functional groups of this kind suitably include the same compounds as the monomers (f3) already mentioned. From the group of the vinyl monomers (f3) or (G) it is then possible to select a complementary pairing whose functional groups are able to react with one another in a condensation or addition reaction. One partner is used in the copolymerization for synthesizing the polymer (F), the other serving as reactant in the polymer-analagous reaction.

Particularly suitable here are pairings such as (meth)acryloyl isocyanate/hydroxyalkyl (meth)acrylate, hydroxyalkyl (meth)acrylate/(meth)acrylic anhydride, and hydroxyalkyl (meth)acrylate/(meth)acryloyl chloride. A particularly preferred combination is that of glycidyl methacrylate or glycidyl acrylate with methacrylic acid or acrylic acid.

A further possible way of obtaining a free-radically crosslinkable polymer is to carry out partial hydrolysis of the ester groups that may be present in the copolymer (F) and then to react the resultant carboxyl groups with glycidyl methacrylic esters or glycidyl acrylic esters.

The polymer-analogous reaction of the polymers (F) with the monomeric functional vinyl compounds (G) complementary thereto to give the free-radically crosslinkable, vinyl-bearing polymers takes place at reaction temperatures from 70 to 150° C., preferably from 80 to 150° C., with particular preference 90-140° C. and especially 100-130° C., with residence times of from 3 to 20 minutes and a conversion of from 50 to 100%.

The reaction takes place with particular preference in a reaction extruder.

Suitable catalysts include all those which are commonly used for accelerating the reaction between the complementary groups. For example, for the reaction pairing of epoxide/carboxylic acid, phosphines such as triphenylphosphine and also amines such as dimethylbenzylamine, dimethylethanolamine and tributylamine, and also tetraalkylammonium halides, are suitable examples, and for the reaction pairing isocyanate/alcohol, organotin compounds are suitable examples.

The ratio of functional groups of the polymer (F) to the functional vinyl monomers (G) is preferably from 0.7:1 to 1.3:1, more preferably from 0.8:1 to 1.2:1, and with very particular preference 1:1.

An excess of functional groups in the polymer (F) may serve to modify the properties of the crosslinked polymer, for example, to make it less susceptible to electrostatic charging. Such free groups are, in particular, the carboxyl group, the hydroxyl group, and the carboxamido group.

The monomers employed in excess or unreacted, (G), are customarily removed again by devolatilization, in an extruder, for example.

In order to prevent premature thermal crosslinking, it may be advisable to add from 1 to 5000 ppm, preferably from 1 to 1000 ppm, of inhibitors to the polymers (F) prior to the polymer-analogous reaction. Examples of suitable inhibitors include phenylthiazines, sterically hindered o-phenols, and monoethers of hydroquinone.

The copolymer (F) is used in solution or dispersion with a solids content of at least 60% by weight, preferably from 80 to 90% by weight, with particular preference free from volatile constituents.

Owing to the usually high viscosity of the reaction mixtures and the short reaction times required, the polymer-analogous reactions may be conducted to particularly favorable effect in an extruder, especially in a self-cleaning multiscrew extruder.

Preferred polymer-analogously modified copolymers are obtainable by polymer-analogous reaction of epoxy-containing (meth)acrylic polymers (H) with at least one olefinically unsaturated aliphatic C₃ to C₆ monocarboxylic acid (J).

Suitable epoxy-functional (meth)acrylate copolymers (H) for preparing the polymer-analogous reaction products of the invention include in particular copolymers of acrylic esters and/or methacrylic esters containing in copolymerized form from 40 to 95% by weight of acrylic esters and/or methacrylic esters and from 5 to 60% by weight and in particular from 10 to 35% by weight of a copolymerizable, olefinically unsaturated monomer containing an epoxide group.

Suitable esters of acrylic and/or methacrylic acid are in particular alkyl esters having from 1 to 10 carbon atoms in the alkyl radical such as methyl methacrylate, methyl acrylate, ethyl acrylate, ethyl methacrylate, isopropyl acrylate, butyl acrylates and methacrylates, such as n-butyl acrylate and n-butyl methacrylate, 2-ethylhexyl acrylate, 2-ethylhexyl methacrylate and n-decyl acrylate.

The copolymers may also, however, contain other copolymerizable olefinically unsaturated monomers in copolymerized form, examples being styrene, α-methylstyrene, acrylonitrile, methacrylonitrile, vinyl ethers and vinyl esters such as vinyl acetate, provided the other monomers contain no functional groups which substantially impair the polymer-analogous reaction between the epoxy groups and carboxyl groups. Examples of suitable copolymers of olefinically unsaturated monomers containing an epoxide group are, in particular, olefinically unsaturated glycidyl esters and glycidyl ethers such as allyl glycidyl ether, glycidyl crotonate, and, preferably, glycidyl methacrylate and glycidyl acrylate.

By an appropriate selection of monomers forming “hard” homopolymers (T_{g}>20° C.) and “soft” homopolymers (T_{g}<0° C.) and of the molecular weight ranges and also of the polydispersity M_{w}/Mₙ, it is possible in a manner known per se to prepare copolymers (H) suitable for the intended use of the polymer-analogous reaction products.

Suitable monomers forming hard and soft homopolymers are described, for example, in Ullmann's Encyclopedia of Industrial Chemistry, 5th Ed., Vol. A21, p. 169 (1992).

The copolymers (H) preferably have an average molecular weight Mₙ from about 1500 to 10 000 and in particular from about 1500 to 6000 and a polydispersity M_{w}/Mₙ of less than 4 and in particular less than 3.

The preparation of such copolymers (H) is known per se (cf., e.g., EP-B 156 170 or DE-A 43 37 481) and takes place preferably by free-radical copolymerization in the absence of solvent or in solution at temperatures above 150° C. in a short polymerization time (<90 minutes, preferably <25 minutes) to a conversion of from about 80 to 90% with subsequent devolatilization of the copolymer (H).

Monomers (J) containing carboxylic acid groups for the polymer-analogous reaction are olefinically unsaturated aliphatic C₃-C₆ monocarboxylic acids, such as acrylic acid, methacrylic acid, crotonic acid and/or alkyl monoesters of olefinically unsaturated aliphatic C₄-C₈ dicarboxylic acids, such as C₁-C₁₀ alkyl monoesters of maleic or fumaric acid. Preference is given to the reaction of the copolymers (H) with acrylic acid and/or methacrylic acid.

In order to prevent the formation of crosslinks and to achieve a high degree of conversion of the epoxide groups of the copolymer (H) during the polymer-analogous reaction it has proven essential to react the copolymer (H) with a marked molar excess of the carboxyl groups of the monomer (J) in relation to the amount of the epoxide groups of the copolymer (H). Accordingly, the copolymer is reacted with from 1.5 to 3 and preferably from 2 to 3 equivalents, based on the amount of the epoxide groups of the copolymer (H), of the unsaturated carboxylic acid (J).

In order to achieve a high degree of conversion of the epoxide groups of the copolymer (H) of at least 80% and preferably at least 90 to 95% it is possible to use a tetraalkylammonium halide, especially a bromide or a chloride, as an accelerator of the epoxide-carboxylic acid reaction during the polymer-analogous reaction, with each alkyl group in the ammonium salt generally containing from 1 to 10 carbon atoms. Preferred tetraalkylammonium halides are those whose alkyl groups each contain from 4 to 8 carbon atoms. Tetra-n-butylammonium bromide has proven a very suitable reaction accelerator. The amount of the admixed tetraalkylammonium halide can in general be from 0.1 to 3% by weight and in particular from 0.5 to 3% by weight, based on the copolymer (H).

The polymer-analogous reaction takes place customarily in a highly concentrated solution with a copolymer (H) solids content of at least 60% and in particular at least 70%, but preferably takes place substantially without solvent or completely without solvent at a temperature of from 100 to 150° C. and more preferably from 120 to 150° C., with effective commixing of the reactants. The reaction is generally ended when a degree of conversion of the epoxide groups of the copolymer (H) of at least 80%, preferably at least 90 to 98%, has been reached. The reaction time is preferably less than 30 minutes.

The polymer-analogous reaction can take place in known reactors such as stirred tanks, for example. Downstream of the reactors there may also advantageously be mixers, which make it possible to achieve a further increase in the degree of conversion of the epoxide groups of the copolymer.

It is further appropriate to follow the reactors for reacting the monomers (J) with the copolymer (H) by reactors in which the reaction product can be substantially freed from volatile constituents by application of a subatmospheric pressure.

The polymer-analogous reaction is preferably conducted substantially without solvent in a continuously operated reactor, the average residence time being in particular from 12 to 30 and preferably from 12 to 20 minutes. At the high viscosity of the reaction mixture is has been found particularly advantageous to use, as the reactors, extruders, and especially multiscrew extruders, which allow very thorough commixing of the reaction mixture at the reaction temperature in a very short time, an extruder temperature of from 100 to 150° C. and preferably from 120 to 150° C. having proven advantageous. An overview of designs of continuous reactors and criteria for their selection is given, for example, by H. Thiele and H. D. Zettler, “Kontinuierliche Reaktionsmaschinen” in “Polymerreaktionen und reaktives Aufbereiten in kontinuierlichen Maschinen”, VDI-Verlag, Düsseldorf 1988, and by H. Herrmann “Schneckenmaschinen in der Verfahrenstechnik”, Springer-Verlag, Berlin-Heidelberg-New York 1972. Highly suitable for the polymer-analogous reaction of the copolymers (H) without solvent with the reactive monomers are multiscrew extruders and, in particular, twin-screw machines with corotating screws, such as the twin-screw ZSK extruders from Werner & Pfleiderer. In such extruders, after a first feed zone and conveying zone, the copolymer (H), heated to approximately reaction temperature and melted, may be mixed with the reactive monomer (J) and with the added reaction accelerator in a second zone. In a third zone of the extruder or in a downstream second extruder, such as a corotating twin-screw extruder (e.g., of type ZSK 58 from Werner & Pfleiderer), the reacted mass is then advantageously devolatilized, i.e., freed substantially from volatile constituents by application of a subatmospheric pressure, it being possible for the temperature in the devolatilizing zone to be the same as or different than the reaction temperature, depending on the subatmospheric pressure applied. Subsequently the mass, which is generally in the form of a melt, is discharged. This may be followed, for example, by further processing to give powders of appropriate particle diameter.

The reaction products have glass transition temperatures in the range, in particular, from −20 to +70° C. and are readily film-forming.

Particularly preferred compounds (A) are urethane or carbonate (meth)acrylates or urethane or carbonate vinyl ethers or polymer-analogously modified, free-radically crosslinkable copolymers, and especially urethane (meth)acrylates or polymer-analogously modified, free-radically crosslinkable copolymers.

Compounds (A) are often used in a mixture with compounds (B), which serve as reactive diluents.

Suitable reactive diluents (compounds (B)) include radiation-curable, free-radically or cationically polymerizable compounds containing only one ethylenically unsaturated, copolymerizable group.

Mention may be made, for example, of C₁-C₂₀ alkyl (meth)acrylates, vinylaromatics having up to 20 carbon atoms, vinyl esters of carboxylic acids containing up to 20 carbon atoms, ethylenically unsaturated nitriles, vinyl ethers of alcohols containing from 1 to 10 carbon atoms, and aliphatic hydrocarbons having from 2 to 8 carbons and 1 or 2 double bonds.

For the purposes of this specification, (meth)acrylic acid is a term used to embrace acrylic acid and methacrylic acid.

Preferred (meth)acrylic acid alkyl esters are those with a C₁-C₁₀ alkyl radical, such as methyl methacrylate, methyl acrylate, n-butyl acrylate, ethyl acrylate and 2-ethylhexyl acrylate.

Mixtures of the (meth)acrylic acid alkyl esters as well are particularly suitable.

Examples of vinyl esters of carboxylic acids having from 1 to 20 carbon atoms include vinyl laurate, vinyl stearate, vinyl propionate, and vinyl acetate.

Suitable vinyl aromatic compounds include vinyltoluene, α-butylstyrene, 4-n-butylstyrene, 4-n-decylstyrene, and, preferably, styrene.

Examples of nitrites are acrylonitrile and methacrylonitrile.

Examples of suitable vinyl ethers are vinyl methyl ether, vinyl isobutyl ether, vinyl hexyl ether, and vinyl octyl ether.

As nonaromatic hydrocarbons that have from 2 to 8 carbon atoms and one or two olefinic double bonds, mention may be made of butadiene, isoprene, and also ethylene, propylene, and isobutylene.

It is further possible to use N-vinylformamide, N-vinylpyrrolidone, and N-vinylcaprolactam.

As photoinitiators (C) it is possible to use photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Ed.), SITA Technology Ltd, London.

Suitable examples include mono- and bisacylphosphine oxides such as Irgacure 819 (bis(2,4,6-trimethylbenzoyl)phenylphosphine oxide), such as are described, for example, in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO), ethyl 2,4,6-trimethylbenzoylphenylphosphinate, benzophenones, hydroxyacetophenones, phenylglyoxylic acid and its derivatives or mixtures of these photoinitiators. Examples that may be mentioned include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-di-iso-propylthioxanthone, 2,4-dichlorothioxanthone, benzoin, benzoin iso-butyl ether, chloroxanthenone, benzoin tetrahydropyranyl ether, benzoin methyl ether, benzoin ethyl ether, benzoin butyl ether, benzoin iso-propyl ether, 7-H-benzoin methyl ether, benz[de]anthracen-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ole, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinone such as 2-methylanthraquinone, 2-ethylanthraquinone, 2-tert-butylanthraquinone, 1-chloroanthraquinone, 2-amylanthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Of said photoinitiators, preference is given to phosphine oxides, α-hydroxy ketones, and benzophenones.

In particular it is also possible to use mixtures of different photoinitiators.

The photoinitiators may be used alone or in combination with a photopolymerization promoter, of the benzoic acid, amine or similar type, for example.

Examples of further, typical coatings additives (D) that can be used include antioxidants, oxidation inhibitors, stabilizers, activators (accelerators), fillers, pigments, dyes, devolatilizers, luster agents, antistatic agents, flame retardants, thickeners, thixotropic agents, level assistants, binders, antifoams, fragrances, surface-active agents, viscosity modifiers, plasticizers, tackifying resins (tackifiers), chelate formers or compatibilizers (see below).

Accelerators which can be used for the thermal aftercure include tin octoate, zinc octoate, dibutyltin laurate or diaza[2.2.2]bicyclooctane, for example.

It is also possible to add one or more photochemically and/or thermally activatable initiators, e.g., potassium peroxodisulfate, dibenzoyl peroxide, cyclohexanone peroxide, di-tert-butyl peroxide, azobis-iso-butyronitrile, cyclohexylsulfonyl acetyl peroxide, di-iso-propyl percarbonate, tert-butyl peroktoate or benzpinacol, and also, for example, thermally activatable initiators which have a half life at 80° C. of more than 100 hours, such as di-t-butyl peroxide, cumene hydroperoxide, dicumyl peroxide, t-butyl perbenzoate, silylated pinacols, available commercially for example under the trade name ADDID 600 from Wacker, or hydroxyl-containing amine N-oxides, such as 2,2,6,6-tetramethylpiperidine-N-oxyl, 4-hydroxy-2,2,6,6-tetramethylpiperidine-N-oxyl, etc.

Further examples of suitable initiators are described in “Polymer Handbook”, 2nd edition, Wiley & Sons, New York.

Suitable thickeners beside free-radically (co)polymerizable (co)polymers include customary organic and inorganic thickeners such as hydroxymethylcellulose or bentonite.

As chelate formers it is possible, for example, to use ethylenediamineacetic acid and its salts and also β-diketones.

Suitable fillers include silicates, e.g., silicates obtainable by hydrolysis from silicon tetrachloride, such as Aerosil® from Degussa, siliceous earth, talc, aluminosilicates, magnesium silicates, calcium carbonates, etc.

Suitable stabilizers embrace typical UV absorbers such as oxanilides, triazines, and benzotriazol (the latter obtainable as Tinuvin® grades from Ciba-Spezialitätenchemie), and benzophenones. These may be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are normally used in amounts of from 0.1 to 5.0% by weight, based on the solid components present in the formulation.

Suitable stabilizers further include, for example, N-oxyls, such as 4-hydroxy-2,2,6,6-tetramethylpiperidine-N-oxyl, 4-oxo-2,2,6,6-tetramethylpiperidine-N-oxyl, 4-acetoxy-2,2,6,6-tetramethylpiperidine-N-oxyl, 2,2,6,6-tetramethylpiperidine-N-oxyl, 4,4′,4″-tris(2,2,6,6-tetramethylpiperidine-N-oxyl) phosphite or 3-oxo-2,2,5,5-tetramethylpyrrolidine-N-oxyl, phenols and naphthols, such as p-aminophenol, p-nitrosophenol, 2-tert-butylphenol, 4-tert-butylphenol, 2,4-di-tert-butylphenol, 2-methyl-4-tert-butylphenol, 4-methyl-2,6-tert-butylphenol (2,6-tert-butyl-p-cresol) or 4-tert-butyl-2,6-dimethylphenol, quinones, such as hydroquinone or hydroquinone monomethyl ether, aromatic amines, such as N,N-diphenylamine, and N-nitrosodiphenylamine, phenylenediamines, such as N,N′-dialkyl-para-phenylenediamine, in which the alkyl radicals may be identical or different and may each be composed independently of one another of from 1 to 4 carbon atoms and may be straight-chain or branched, hydroxylamines, such as N,N-diethylhydroxylamine, urea derivatives, such as urea or thiourea, phosphorous compounds, such as triphenylphosphine, triphenyl phosphite or triethyl phosphite, or sulfur compounds, such as diphenyl sulfide or phenothiazine.

Typical compositions for (I) are by way of example
(A) 40-100% by weight, preferably 50-90%, with particular preference 60-90%, and especially 60-80% by weight,
(B) 0-60% by weight, preferably 5-50%, with particular preference 6-40%, and especially 10-30% by weight,
(C) 0-20% by weight, preferably 0.5-15%, with particular preference 1-10%, and especially 2-5% by weight, and
(D) 0-50% by weight, preferably 2-40%, with particular preference 3-30%, and in particular 5-20% by weight,
   with the proviso that (A), (B), (C) and (D) together make up 100% by weight.

In particularly preferred radiation-curable compositions the compound (A) is composed of from 10 to 100% by weight, based on the total amount of the compound (A), of urethane (meth)acrylate(s), polymer-analogously modified copolymers, epoxy acrylates, polyether acrylates or polyester acrylates.

Suitable pressure-sensitive adhesives (II) are those which are miscible with the radiation-curable compositions (I). Miscible here means that they are completely miscible with one another at the curing temperature in the range of the composition of (I) and (II) (see below). The term embraces both complete solubility of the pressure-sensitive adhesive (II) in the radiation-curable composition (I) and systems in which there is a miscibility gap; preferably, the pressure-sensitive adhesives (II) are soluble in (I).

It is preferred not to use those adhesives which require an additional compound as a curing component. Examples of such compounds include polyepoxide compounds, e.g., polyepoxide compounds having a molecular weight of below 2000 g/mol, especially those having an epoxide value of from 1 to 15.

The curing temperature of the adhesives (II) lies above the glass transition temperature T_{g} of the binder (A) and of the reactive diluents (B), where used, and is for example at least 20° C. higher, preferably at least 30° C. higher, and with particular preference at least 50° C. higher. The upper limit of the curing temperature is dictated by the thermal stability of the coating substrate.

Typical curing temperatures are situated at 40-120° C., preferably 50-110° C., and with particular preference 60-100° C.

The temperature may remain the same or may be raised in the course of the curing process.

The duration of curing is generally between a few minutes and a few hours, from 1 minute to 5 hours for example, from 2 minutes to 3 hours for preference, from 5 minutes to 2 hours for particular preference, and from 10 minutes to 1 hour particularly.

Particularly suitable pressure-sensitive adhesives (II) are those which comprise at least one adhesive composition which can be crosslinked by means of active radiant energy.

According to the definition on “CD Römpp Chemie Lexikon—Version 1.0, Stuttgart/New York: Georg Thieme Verlag 1995”, pressure-sensitive adhesives (PSAs) are viscoelastic adhesives which remain permanently tacky and adhesive in solvent-free form at room temperature and which, with little substrate specificity, adhere immediately to virtually all substrates under gentle applied pressure. A similar definition is given in “Handbook of Pressure Sensitive Adhesive Technology”, Donatas Satas (Ed.), 1999, Chapter 1. Typical substrates for pressure-sensitive adhesives are glass, plastics and metals.

Particularly suitable PSAs are those which exhibit a permanent tack at room temperature, e.g., which have a glass transition temperature T_{g} of more than −60° C., preferably from −60° C. to −10° C.

The glass transition temperature can be determined by customary methods such as differential thermal analysis or differential scanning calorimetry (DSC, see, e.g., ASTM 3418/82, midpoint temperature).

Besides the pressure-sensitive adhesives of the invention it is also possible to use structural adhesives which are common knowledge, such as urethanes, epoxy adhesives or phenol-formaldehyde resins.

Among the pressure-sensitive adhesives, the acrylic adhesives are preferred. These are adhesives based on acrylic monomers, especially based on acrylic esters and methacrylic esters. They are solutions or dispersions of polyacrylates or polymethacrylates. In many cases they comprise (co)polymers based on ethyl acrylate and/or butyl acrylate, whose properties, e.g., hardness and elasticity, can be set as desired during the polymerization by the concomitant use of suitable comonomers, e.g., methacrylates, and which may contain additional functional groups (carboxyl, hydroxyl groups) for the purpose of improving the adhesion properties.

(Meth)acrylate adhesives are described, for example, in G. Auchter, O. Aydin, A. Zettl, D. Satas, “Acrylic Adhesives”, Chapter 19 of the “Handbook of Pressure Sensitive Adhesive Technology”, Donatas Satas (Ed.), 1999.

Their composition is generally as follows:

Principal monomer 50-98% by weight
Secondary monomer 10-40% by weight
Functionalized monomer 0.5-20% by weight.

Examples of principal monomers therein are methyl (meth)acrylate, ethyl (meth)acrylate, n-propyl (meth)acrylate, n-butyl (meth)acrylate, iso-butyl (meth)acrylate, sec-butyl (meth)acrylate, n-pentyl (meth)acrylate, iso-pentyl (meth)acrylate, 2-methylbutyl (meth)acrylate, amyl (meth)acrylate, n-hexyl (meth)acrylate, 2-ethylbutyl (meth)acrylate, pentyl (meth)acrylate, n-heptyl (meth)acrylate, n-octyl (meth)acrylate, 2-ethylhexyl (meth)acrylate, n-decyl (meth)acrylate, undecyl (meth)acrylate, n-dodecyl (meth)acrylate, 2-methoxyethyl (meth)acrylate, 2-ethoxyethyl (meth)acrylate, 4-methoxybutyl (meth)acrylate, 2-(2′-methoxyethoxy)ethyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, ethylene glycol (meth)acrylate, propylene glycol (meth)acrylate, 1,6-hexanediol di(meth)acrylate, 1,2-ethylene glycol di(meth)acrylate, diethylene glycol di(meth)acrylate, triethylene glycol di(meth)acrylate, tetraethylene glycol di(meth)acrylate, trimethylolpropane tri(meth)acrylate, trimethylolethane tri(meth)acrylate, pentaerythritol tri- and tetra(meth)acrylate, vinyl chloride, vinylidene chloride, vinyl acetate, vinyl propionate, vinyl butyrate, methyl vinyl ketone, vinyltoluene, vinylnaphthalene, methyl vinyl ether, ethyl vinyl ether, n-propyl vinyl ether, iso-propyl vinyl ether, n-butyl vinyl ether, sec-butyl vinyl ether, iso-butyl vinyl ether, tert-butyl vinyl ether, 4-hydroxybutyl vinyl ether, n-octyl vinyl ether, ethylene, propylene, 1-butene, 2-butene, iso-butene, cyclopentene, cyclohexene, cyclododecene, butadiene, isoprene, chloroprene, styrene, α-methylstyrene, divinylbenzene, tert-butylstyrene, and mixtures thereof.

Examples of suitable secondary monomers include

iso-bornyl (meth)acrylate, tridecyl (meth)acrylate, lauryl (meth)acrylate, stearyl (meth)acrylate, 10-cyclohexylundecyl (meth)acrylate, 2-cyanoethyl (meth)acrylate, 2-dimethylaminoethyl (meth)acrylate, glycidyl (meth)acrylate, 3-(trimethoxysilyl)propyl (meth)acrylate, 2-(trimethoxysilyl)ethyl (meth)acrylate, N-(2-hydroxyethyl)(meth)acrylamide, N,N-dimethyl(meth)acrylamide, N-tert-butyl(meth)acrylamide, N-octyl(meth)acrylamide, acrolein, (meth)acrylonitrile, di-iso-propyl fumarate, di-n-butyl fumarate, di-sec-butyl fumarate, diamyl fumarate, di-2-ethylbutyl fumarate, di-n-octyl fumarate, di-2-ethylhexyl fumarate, didodecyl fumarate, bis(2-hydroxyethyl) fumarate, dibutyl maleate, di-2-ethylhexyl maleate, di(2-hydroxyethyl)maleate, maleic mononitrile, maleic dinitrile, vinyl valerate, divinyl ether, 2-chloroethyl vinyl ether, α-propiolactone, δ-valerolactone, ε-caprolactone, N-vinylformamide, N-vinylacetamide, N-vinyl-N-methylformamide, N-vinyl-N-methylacetamide, allylacetic acid, vinylacetic acid, and mixtures thereof.

Examples of functionalized monomers include monomers containing carboxyl, hydroxyl, epoxy, allyl, carboxamido, amine, isocyanate, hydroxymethyl, methoxymethyl, and silyloxy groups. These monomers can be, for example, (meth)acrylic acid, (meth)acrylic acid formal, hydroxymethyl (meth)acrylate, benzophenone glycidyl (meth)acrylate, 2-sulfoethyl (meth)acrylate, (meth)acrylamide, N-methylol(meth)acrylamide, fumaric acid, mono-iso-propyl fumarate, mono-n-hexyl fumarate, fumaric monoamide, fumaric diamide, fumaric mononitrile, fumaric dinitrile, crotonic acid, glycidyl crotonate, itaconic acid, itaconic monoesters, itaconic anhydride, citraconic acid, citraconic monoesters, citraconic anhydride, succinic acid, maleic acid, monomethyl maleate, monoethyl maleate, monobutyl maleate, maleic anhydride, maleic monoamide, maleic diamide, N-methylolmaleiamide, vinylsuccinimide, vinylimidazole, 2-vinylpyridine, 4-vinylpyridine, N-vinylpyrrolidone, N-vinylpiperidone, N-vinylcaprolactam, sodium vinylsulfonate, tetraallyloxyethane, diallyl phthalate, diallyl succinate, tetraallylethane, tetraallyloxysilane, allyl glycidyl ether, triallyl cyanurate, triallyl isocyanurate, diketene, monoethylenically unsaturated carboxylic acids having from 3 to 8 carbon atoms and their water-soluble alkali metal, alkaline earth metal or ammonium salts, such as for example: acrylic acid, methacrylic acid, dimethylacrylic acid, ethacrylic acid, maleic acid, citraconic acid, methylenemalonic acid, crotonic acid, fumaric acid, mesaconic acid, itaconic acid, maleic acid, and mixtures thereof.

The weight-average molar weight of the acrylic pressure-sensitive adhesives, where appropriate prior to further crosslinking (and as determined by gel permeation chromatography using polystyrene as standard and tetrahydrofuran as eluent), is situated for example between 200 000 and 1 500 000 g/mol, preferably between 250 000 and 1 200 000, with particular preference between 300 000 and 900 000.

The gel content, i.e., the fraction of an adhesive film that is soluble in THF on storage at room temperature for 24 hours, is between 30 and 70% by weight, preferably between 30 and 60% by weight, and with particular preference between 40 and 60% by weight.

The glass transition temperature of the acrylic adhesive, measured by the DSC method, is between −60 and −10° C., preferably between −55 and −20° C., and with particular preference between −55 and −30° C.

Adhesives particularly suitable in accordance with the invention as pressure-sensitive adhesives (II) are radiation-crosslinkable adhesives.

These are adhesives which can be crosslinked by means of active irradiation of energy. These adhesives generally contain poly(meth)acrylate, preferably polyacrylate, where appropriate in combination with aliphatic or aromatic epoxy resins, urethanes, polyesters or polyethers. Preference is given to using epoxy resins and aliphatic, aromatic or mixed aliphatic/aromatic urethanes.

Crosslinking takes place by active irradiation of energy but can also take place by way of a second curing mechanism or further curing mechanisms (dual cure), e.g., by moisture, oxidation or the effect of heat, preferably by means of heat, at the stated curing temperature, for example.

In order to reduce the viscosity these adhesives may be admixed with reactive diluents, such as, for example, the compounds listed under (B).

A further option is to admix crosslinking monomers, examples being 1,3-butylene glycol di(meth)acrylate, tripropylene glycol di(meth)acrylate, trimethylolpropane triacrylate, and pentaerythritol tetraacrylate.

For crosslinking by UV light it is possible to add a photoinitiator, examples being the compounds described under (C).

However, the photoinitiator may also be attached to the poly(meth)acrylate. In that case the photoinitiator might comprise, for example, cyclic imide structures, e.g., maleimide or maleimide derivatives, benzophenone or acetophenone groups. The latter are described, for example, in EP-B1 377 199, page 3, line 14 to page 13, line 45, and in EP-A 395 987, page 3, line 24 to page 5, line 42, and are hereby incorporated by reference.

Particularly suitable are the UV acrylates acResin® A 203 UV and acResin® A 258 UV from BASF AG.

Through irradiation with high-energy light, especially UV light, the photoinitiator brings about crosslinking of the poly(meth)acrylate, preferably by means of a chemical grafting reaction of the photoinitiator with a spatially adjacent polymer chain. The crosslinking may take place in particular through insertion of a carbonyl group of the photoinitiator into an adjacent C—H bond to form a —C—C—O—H group.

At least one photoinitiator (C) may be added to the poly(meth)acrylate in amounts of preferably from 0.0001 to 1 mol, with particular preference from 0.0002 to 0.1 mol, with very particular preference from 0.0003 to 0.01 mol, or the poly(meth)acrylate contains these amounts in the form of a photoinitiator-active molecule group which is attached to the poly(meth)acrylate. These amounts are based on 100 g of poly(meth)acrylate.

The photoinitiator preferably comprises an acetophenone, benzophenone, benzoin ethers, benzil dialkyl ketals, or derivatives thereof.

The photoinitiator is preferably attached to the poly(meth)acrylate.

With particular preference the photoinitiator is one which has been incorporated into the polymer chain by free-radical copolymerization. For this purpose the photoinitiator preferably contains an acrylic, methacrylic or vinyl ether group.

Suitable copolymerizable photoinitiators are acetophenone or benzophenone derivatives which preferably contain at least one ethylenically unsaturated group. The ethylenically unsaturated group is preferably an acryloyl or methacryloyl group.

The ethylenically unsaturated group may be attached directly to the phenyl ring of the acetophenone derivative or benzophenone derivative. In general there is a spacer group located between phenyl ring and ethylenically unsaturated group.

The spacer group may contain, for example, up to 100 carbon atoms.

Suitable acetophenone derivatives or benzophenone derivatives are described, for example, in EP-A-346 734, page 3, line 8 to page 6, line 50, DE-A-4 037 079, page 3, line 46 to page 6, line 45 and DE-A-3 844 444 page 5, line 52 to page 16, line 56, and are incorporated by this reference into the present specification.

Preferred acetophenone and benzophenone derivatives are those of the formula

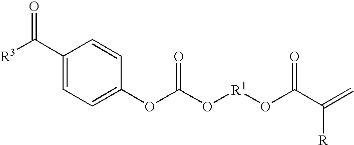

where R¹ is an organic radical having up to 30 carbon atoms, R² is a hydrogen atom or a methyl group, and R³ is an unsubstituted or substituted phenyl group or a C₁-C₄ alkyl group.

R¹ is with particular preference an alkylene group, especially a C₂-C₈ alkylene group.

The glass transition temperature (T_{g}) by the DSC method of the radiation-crosslinkable polyacrylate or of the radiation-crosslinkable adhesive composition is preferably from −60 to +10° C., with particular preference from −55 to 0° C., with very particular preference from −55 to −10° C.

The radiation-crosslinkable or without radiation curable polyacrylates which can be used in accordance with the invention may typically be processed at a temperature of from 20 to 130° C.

The dynamic viscosity at this temperature is generally from 1 to 100 Pas, preferably from 5 to 80 Pas, with particular preference from 10 to 60 Pas, and in particular from 20 to 60 Pas.

The weight-average molar weight of the radiation-crosslinkable acrylic PSAs, where appropriate prior to further crosslinking (and as determined by gel permeation chromatography using polystyrene as standard and tetrahydrofuran as eluent), is for example between 200 000 and 1 500 000 g/mol, preferably between 250 000 and 1 200 000, with particular preference between 300 000 and 900 000.

The gel content, i.e. the fraction of an adhesive film that is soluble in THF on storage at room temperature for 24 hours, is between 30 and 70% by weight, preferably between 30 and 60% by weight, and with particular preference between 40 and 60% by weight.

The radiation-crosslinkable adhesives generally exhibit a wavelength range having at least one absorption maximum, for which irradiation within said wavelength range results in an increased fraction of crosslinked product. This absorption maximum can easily be determined in tests customary within the art, by carrying out irradiation at different doses in the individual absorption maxima and measuring the properties of the products. An approach of this kind is described, for example, in K.-H. Schumacher, U. Düsterwald, B. Meyer-Roscher, “UV-vernetzbare Acrylatklebstoffe”, Paper given at the VIIIth Adhesive Tape Forum, Munich, 1998.

The radiation-crosslinkable polyacrylates which can be used in accordance with the invention crosslink on irradiation at a wavelength of up to 300 nm, preferably in the UV-C region at wavelengths of between 150 and 260 nm, with particular preference in the range from 200 to 260 nm, and in particular from 250 to 260 nm.

The radiation dose in this range should be at least 1 mJ/cm², preferably at least 5 mJ/cm², with particular preference at least mJ/cm², and in particular at least 20 mJ/cm².

The radiation-crosslinkable adhesives may be admixed with other resins which increase the tack (tackifiers). These may be, for example, the abovementioned pressure-sensitive adhesives, provided they do not absorb within the same UV region necessary for the crosslinking of the radiation-crosslinkable adhesive, examples being resin acid, hydrated, fully or partly esterified colophony resins, (rosins), such as rosin acid, polymeric rosin acid or rosin esters, for example, such as partly or fully hydrogenated abietic esters, Foral® 85 E or Foral 105 (from Hercules), terpene resins, terpene-phenolic resins, aromatic hydrocarbon resins, aliphatic saturated hydrocarbon resins, and petroleum resins.

For preparing the mixtures of the invention the components (A), (B), (C) or (D), and also (I) or (II), may where appropriate be dispersed in a suitable solvent (III).

Dispersion in this text is used as a superordinate term in accordance with Römpp Chemie Lexikon—CD Version 1.0, Stuttgart/New York: Georg Thieme Verlag, 1995, and embraces emulsions, suspensions, and solutions.

Examples of suitable solvents (III) include water, methanol, ethanol, iso-propanol, n-propanol, n-butanol, ethylene glycol, diethylene glycol, triethylene glycol, ethylene glycol dimethyl ether, diethylene glycol dimethyl ether, triethylene glycol dimethyl ether, ethylene glycol diethyl ether, diethylene glycol diethyl ether, triethylene glycol diethyl ether, acetone, iso-butyl methyl ketone, diethyl ketone, dimethylformamide, dimethyl sulfoxide, dioxane, tetrahydrofuran, tert-butyl methyl ether, tert-butyl ethyl ether, toluene, xylene, pentane, hexane, methyl acetate, ethyl acetate, butyl acetate, methyl propionate, ethyl propionate, butyl propionate, ethylene carbonate, 1,2-propylene carbonate or 1,3-propylene carbonate.

The mixtures of the invention comprise at least one radiation-curable composition (I) and at least one pressure-sensitive adhesive (II).

Exemplary mixtures contain for example
(I) 90-99.9% by weight of the radiation-curable composition (I), preferably 92-99.8% by weight, with particular preference 93-99.5% by weight, and with very particular preference 94-99% by weight, and
(II) 0.1-10% by weight of the pressure-sensitive adhesive (II), preferably 0.2-8% by weight, with particular preference 0.5-7% by weight, and with very particular preference from 1 to 6% by weight.

(I) and/or (II), and also where appropriate components (A), (B), (C) and/or (D), may be present in dispersion in the solvent (III). In that case the fraction of (III) as a proportion of the respective solution is determined by its dissolution properties. Said fraction may amount to between 10 and 99% by weight, preferably between 20 and 98% by weight, and with particular preference between 30 and 95% by weight.

The mixtures of the invention are prepared by intimately mixing components (I), or its individual components (A) to (D), and (II), and also where appropriate the solvent (III), in any order. This mixing operation can be conducted under inert gas where appropriate.

The temperature during the preparation is not restricted and is generally limited at the bottom end by the freezing temperature or glass transition temperature and at the top end by the boiling point or curing temperature of the respective components or mixtures. For example, the temperature is from 0° C. to 80° C., preferably from 10° C. to 70° C., and with particular preference from 20° C. to 60° C.

The coating of the substrates with the mixtures of the invention takes place in accordance with customary techniques known to the skilled worker, by applying at least one mixture of the invention, in the form for example of a dispersion or else without solvent (III), in the desired thickness to the target substrate and removing the volatile constituents of the dispersion, where appropriate with heating. If desired, this operation may be repeated one or more times.

Application to the substrate may take place in a known way, e.g., by spraying, squirting, dipping, troweling, knifecoating, airblade coating, brushing, rolling, roller application or pouring. The coating thickness is generally situated within a range from about 3 to 1000 g/m² and preferably from 10 to 200 g/m².

Further disclosed is a method of coating substrates which involves applying a coating material comprising a mixture of the invention, where appropriate as a coating formulation with further, typical coatings additives and/or thermally curable resins, to the substrate, drying the coating where appropriate, subjecting it to thermal treatment at the curing temperature indicated above, and subsequently, where appropriate at temperatures up to the level of the curing temperature, curing it with electron beams or UV exposure under an oxygen-containing atmosphere or preferably under inert gas.

The method of coating substrates may also be implemented in such a way that following the application of the mixture or coating formulation of the invention curing is carried out first with electron beams or UV exposure under oxygen or preferably under inert gas and then thermal treatment takes place at the curing temperature.

Thermal and radiation curing can of course also be carried out in parallel.

The curing of the films formed on the substrate may if desired take place exclusively by means of heat. In general, however, the coatings are cured both by exposure to high-energy radiation and thermally.

Where appropriate it is possible, if two or more coats of the coating material are applied one over the other, for a thermal and/or radiation cure to take place after each coating operation.

The finished coating has a glass transition temperature which is above the service temperature, generally above room temperature. Examples of active energy radiation include ultraviolet, X-rays and electron beams, preference being given to ultraviolet and electron beams.

The coating of substrates may also take place as follows, by
i) coating a substrate with a mixture of the invention as described above,
ii) removing volatile constituents of the mixture of the invention, for forming a film, under conditions in which the initiator (C) essentially still does not form any free radicals,
iii) where appropriate, irradiating the film formed in step ii) with high-energy radiation, the film being precured, and then, where appropriate, machining the article coated with the precured film or contacting the surface of the precured film with another substrate, and
iv) carrying out ultimate thermal curing of the film.

Steps iv) and iii) may also be carried out in the opposite order, i.e., the film can be cured first thermally and then with high-energy radiation.

Typical curing temperatures are 40-120° C., preferably 50-110° C., and with particular preference 60-100° C.

The temperature may remain the same or be raised in the course of the curing process.

The curing time is generally between a few minutes and several hours, for example, from 1 minute to 5 hours, preferably from 2 minutes to 3 hours, with particular preference from 5 minutes to 2 hours, and in particular from 10 minutes to 1 hour.

Suitable radiation sources for the radiation cure are, for example, low-pressure, medium-pressure and high-pressure mercury lamps and also fluorescent tubes, pulsed radiators, metal halide lamps, xenon lamps, electrodeless discharge lamps, carbon arc lamps, electronic flash devices, which allow radiation curing without a photoinitiator, or excimer radiators. The radiation cure is effected by exposure to high-energy radiation, i.e., UV radiation or daylight, preferably light in the wavelength range of λ=150 to 700 nm, with particular preference λ=200 to 500 nm, and with very particular preference λ=250 to 400 nm, or by exposure to high-energy electrons (electron beams; 50 to 1000 keV, preferably from 100 to 500 keV, and with particular preference from 150 to 300 keV) using equipment, for example, of the Cockroft-Walton type, van de Graaff type or resonance type. Examples of radiation sources used include high-pressure mercury vapor lamps, lasers, pulsed lamps (flashlights), halogen lamps or excimer radiators. The radiation dose usually sufficient for crosslinking in the case of UV curing is situated in the range from 80 to 3000 mJ/cm².

It is of course also possible to use two or more radiation sources for the curing, e.g., from two to four.

These sources may also radiate each in different wavelength ranges.

Irradiation may where appropriate also be carried out in the absence of oxygen, e.g., under an inert gas atmosphere. Suitable inert gases include preferably nitrogen, noble gases, carbon dioxide, or combustion gases. Irradiation may also be carried out with the coating material covered by transparent media. Examples of transparent media include polymer films, glass or liquids, e.g., water. Particular preference is given to irradiation in the manner described in DE-A 199 57 900.

The mixtures according to the invention, where appropriate in the form of dispersions or coating formulations, are particularly suitable for coating substrates such as wood, paper, textile, leather, nonwovens, plastic surfaces, glass, ceramic, mineral building materials, such as molded cement blocks and fiber cement slabs, or metals or coated metals, preferably glass, plastics or metals. The mixtures according to the invention are particularly suitable for coating metal foils and/or plastic films, where appropriate in the form of composites, especially for coating metal foils and/or plastic films which are used as materials in the foodstuffs field, i.e., for packaging.

By plastics are meant the engineering plastics known per se to the skilled worker, examples being polymers and copolymers containing in copolymerized form (meth)acrylic esters, vinyl aromatic compounds, e.g., styrene, divinylbenzene, vinyl esters, e.g., vinyl acetate, halogenated ethylenically unsaturated compounds, e.g., vinyl chloride, vinylidene chloride, conjugated unsaturated compounds, e.g., butadiene, isoprene, chloroprene, α,β-unsaturated nitrites, e.g., acrylonitrile, monounsaturated compounds, e.g., ethylene, propylene, 1-butene, 2-butene, iso-butene, cyclic monounsaturated compounds, e.g., cyclopentene, cyclohexene, N-vinylpyrrolidone, N-vinyl lactams, such as N-vinyl caprolactam, vinyl ethers, e.g., methyl vinyl ether, ethyl vinyl ether, n-propyl vinyl ether, iso-propyl vinyl ether, n-butyl vinyl ether.

Those that may be mentioned by name include polyethylene, polypropylene, polystyrene, polyesters, polyamides, polyvinyl chloride, polycarbonate, polyvinyl acetal, polyacrylonitrile, polyacetal, polyvinyl alcohol, polyvinyl acetate, phenolic resins, urea resins, melamine resins, alkyd resins, epoxy resins, and polyurethanes.

Particular mention may be made of ABS, AMMA, EP, EPS, EVA, EVAL, HDPE, LDPE, MBS, MF, PA, PA6, PA66, PAN, PB, PBTP, PC, PE, PEC, PEP, PETP, PF, PI, PIB, PMMA, POM, PP, PS, PUR, PVAC, PVAL, PVC, PVDC, PVP, SAN, SB, SMS, UF and UP plastics (symbols in accordance with DIN 7728).

The examples which follow are intended to illustrate the properties of the invention without restricting it, however.

### EXAMPLES

Unless indicated otherwise, “parts” in this specification are by weight.

Irradiation with UV light took place using the following UV unit:

UV lamp output: 80 W/cm
Hg lamp, undoped
Total intensity: 367 mW/cm² measured at 10 m/min
of which:

| | |
|---|---|
| UVV | 67 |
| UVA | 150 |
| UVB | 132 |
| UVC | 18 |

Output: 591 mJ/cm² measured at 10 m/min
of which:

| | |
|---|---|
| UVV | 87 |
| UVA | 249 |
| UVB | 223 |
| UVC | 32 |

Measurement of the intensity and output under glass:
Total intensity: 223 mW/cm² measured at 10 m/min
of which:

| | |
|---|---|
| UVV | 65 |
| UVA | 148 |
| UVB | 10 |
| UVC | 0 |

Output: 339 mJ/cm² measured at 10 m/min
of which:

| | |
|---|---|
| UVV | 87 |
| UVA | 244 |
| UVB | 8 |
| UVC | 0 |

### Wavelength Ranges:

### Wavelength:

| | |
|---|---|
| UV A | 320-390 nm |
| UV B | 280-320 nm |
| UV C | 250-260 nm |
| UV V | 395-445 nm |

Measurement of the intensity and output under polyester film:
Total intensity: 262 mW/cm²
of which:

| | |
|---|---|
| UV A | 172 |
| UV B | 9 |
| UV C | 0 |
| UV V | 81 |

Total output: 364 mJ/cm²
of which:

| | |
|---|---|
| UV A | 259 |
| UV B | 0 |
| UV C | 0 |
| UV V | 105 |

### Example 1

### Composition 1

| | |
|---|---|
| Isopropylidenedicyclohexanol | 40 mol OH |
| Hydroxyethyl acrylate | 55 mol OH |
| Basonat ® HI 100 | 50 mol NCO |
| Basonat ® HB 100 | 50 mol NCO |
| Methanol | 5 mol OH |
| Hydroquinone monomethyl ether | 0.05% based on total |
| | solids |
| Kerobit ® TBK (di-tert-butylkresol) | 0.1% based on total |
| | solids |
| Phenothiazine | 0.005% based on total |
| | solids |
| Solvent: Ethyl acetate | Solids content: 67.9% |

Basonat® HI 100 (polyfunctional isocyanate based on hexamethylene diamine with a high isocyanurate fraction), Basonat® HB 100 (polyfunctional isocyanate based on hexamethylene diamine with a high biuret fraction), and Kerobit® TBK were obtained from BASF AG, Ludwigshafen.

### Formulating Batch:

30 parts of the above composition 1, dissolved from a solids content of 65.4% in ethyl acetate (19.62% by weight)
6.5 parts of AC Resin® A 258 UV (BASF AG, Ludwigshafen), dissolved from a solids content of 15% in ethyl acetate (0.981% by weight)
7.8 parts of Irgacure® 2959 (Ciba Spezialitätenchemie), dissolved from a solids content of 5% in ethyl acetate (0.3924% by weight).
Using a laboratory stirrer at about 2000 rpm, first AC Resin® A 258 UV and then Irgacure® 2959 were added to the above composition 1. This was done at room temperature.

### Experimental Description:

The formulating batch is drawn down wet onto a glass plate (Laro grade, 148 mm×90 mm×2 mm) with a film thickness of 150 μm using a box-type coating bar, conditioned at 60° C. for 15 minutes, after the 15 minutes covered with a second, uncoated glass plate, likewise at 60° C., and immediately exposed to light, twice at 10 m/min, while still hot.
The thickness of the dry film was 43 μm, and there was very good intercoat adhesion.
The glass plates could no longer be separated by hand.

### Comparative Example 1

The procedure of example 1 was repeated but without AC-Resin:
No mutual adhesion was found.
The glass plates slid off from one another without exertion of force.

### Example 2

### Formulating Batch

30 parts of composition 1 from example 1, dissolved from a solids content of 65.4% in ethyl acetate (19.62% by weight)
6.5 parts of AC Resin® A 203 UV (BASF AG, Ludwigshafen), dissolved from a solids content of 15% in ethyl acetate (0.981% by weight)
7.8 parts of Irgacure® 2959 (Ciba Spezialitätenchemie), dissolved from a solids content of 5% in ethyl acetate (0.3924% by weight).
The ingredients were mixed using a laboratory stirrer at about 2000 rpm at room temperature, with first AC Resin® A 203 UV and then Irgacure® 2959 being added to the composition 1 from example 1.

### Experimental Description:

The formulating batch is drawn down wet onto a glass plate (Laro grade, 148 mm×90 mm×2 mm) with a film thickness of 150 μm using a box-type coating bar, conditioned at 60° C. for 15 minutes, after the 15 minutes covered with a second, uncoated glass plate, likewise at 60° C., and immediately exposed to light, twice at 10 m/min, while still hot.
The thickness of the dry film was 39 μm, and there was very good mutual adhesion.
The glass plates could no longer be separated by hand.
The formulating batch is drawn down wet with a film thickness of 30 μm using a wire doctor onto a 12 μm thick polyester film, corona treated, and then is conditioned at 60° C. for 15 minutes, after the 15 minutes is covered with a second polyester film and pressed down with a rubber roller, and then exposed to light twice at room temperature at 10 m/min.
The thickness of the dry film was 76 μm. Very good adhesion was found.
The two films could not be pulled apart from one another by hand without damage.

### Comparative Experiment 2

The procedure described in example 2 was repeated but without AC-Resin: no adhesion was observed.
The glass plates slid easily from one another. The films showed no adhesion.

### Example 3

### Formulating Batch

36.6 parts of composition 1, dissolved from a solids content of 65.4% in ethyl acetate (23.9364% by weight)
11.3 parts of ethyl acetate
4.8 parts of AC Resin® 203 (BASF AG, Ludwigshafen), dissolved from a solids content of 50% in ethyl acetate (2.4% by weight)
9.6 parts of Irgacure® 2959 (Ciba Spezialitätenchemie), dissolved from a solids content of 5% in ethyl acetate (0.48% by weight).
Viscosity: 170 mPa·s
The constituents of the formulation were mixed together at about 2000 rpm using a laboratory stirrer, and at room temperature, with first the 11.3 parts of ethyl acetate being metered in and then the AC Resin® 203 and finally Irgacure® 2959.

### Experimental Description:

The formulating batch is drawn down wet with a film thickness of 30 μm using a wire doctor onto a 12 μm thick polyester film, corona treated, and then is conditioned at 60° C. for 15 minutes, after the 15 minutes is covered with a second polyester film and pressed down with a rubber roller, and then exposed to light twice immediately at 10 m/min.
The thickness of the dry film was 34 μm. Good adhesion was found.
The two films could not be pulled apart from one another by hand without damage.

### Example 4

The formulating batch from example 3 is drawn down wet with a film thickness of 15 μm using a wire doctor onto a 12 μm thick polyester film, corona treated, and is conditioned at 60° C. for 5 minutes after which the formulating batch is again drawn down wet with a film thickness of 15 μm using a wire doctor onto the above-coated polyester film, conditioned again at 60° C. for 5 minutes, after the 5 minutes is covered with a second polyester film and pressed down with a rubber roller, and subsequently is exposed to light twice at room temperature and at 10 m/min.
The thickness of the dry film was about 39 μm.
Good adhesion was found. The two films could not be pulled apart by hand without damage.
Good rigidity was found.

### Comparative Experiment 3

80 parts of the composition 1 from example 1 dissolved from a solids content of 50% in ethyl acetate (40% by weight)
16 parts of Irgacure® 2959 (Ciba Spezialitätenchemie), dissolved from a solids content of 5% in ethyl acetate (0.8% by weight).
The formulating batch is drawn down wet with a film thickness of 30 μm using a wire doctor onto a 12 μm thick polyester film, corona treated, and is conditioned at 60° C. for 15 minutes, after the 15 minutes is covered with a second polyester film, and pressed down with a rubber roller, and then is immediately exposed to light twice at 10 m/min.
The thickness of the dry film was about 30 μm.
No adhesion was found. The two films could be pulled apart by hand without damage.

### Example 5

### Composition 2

5 parts by weight of butyl acrylate
20 parts by weight of glycidyl methacrylate, reacted polymer-analogously with acrylic acid
20 parts by weight of styrene
55 parts by weight of methyl methacrylate

### Formulating Batch:

30 parts of composition 2, dissolved from a solids content of 50% in ethyl acetate (15% by weight).
5 parts of AC Resin® A 258 UV (BASF AG, Ludwigshafen), dissolved from a solids content of 15% in ethyl acetate (0.75% by weight).
6 parts of Irgacure® 2959 (Ciba Spezialitätenchemie), dissolved from a solids content of 5% in ethyl acetate (0.3% by weight).

### Experimental Description:

The formulating batch is drawn down wet with a film thickness of 50 μm using a box-type coating bar onto a glass plate (Laro grade, 148 mm×90 mm×2 mm), and is conditioned at 60° C. for 15 minutes, after the 15 minutes is covered with a second, uncoated glass plate, likewise at 60° C., and is exposed to light immediately twice at 10 m/min while still hot.
Very good mutual adhesion was found.
The glass plates could no longer be separated by hand.

### Comparative Example 4

The procedure of example 5 was repeated but without AC-Resin: no mutual adhesion was observed.
The glass plates slid easily from one another.

### Example 6

### Formulating Batch B

30 parts of composition 2 from example 5, dissolved from a solids content of 50% in ethyl acetate (15% by weight).
5 parts of AC Resin® A 203 UV (BASF AG, Ludwigshafen), dissolved from a solids content of 15% in ethyl acetate (0.75% by weight).
6 parts of Irgacure® 2959 (Ciba Spezialitätenchemie), dissolved from a solids content of 5% in ethyl acetate (0.3% by weight).

### Experimental Description:

The formulating batch was drawn down wet with a film thickness of 50 μm using a box-type coating bar onto a glass plate (Laro quality, 148 mm×90 mm×2 mm), and was conditioned at 60° C. for minutes, after the 15 minutes was covered with a second, uncoated glass plate, likewise at 60° C., and was immediately exposed to light twice at 10 m/min while still hot.
Very good mutual adhesion was found.
The glass plates could no longer be separated by hand.

### Comparative Experiment 5

The procedure of example 6 was repeated but without AC-Resin: no mutual adhesion was observed.
The glass plates slid easily from one another.

1-18. (canceled)

19: A mixture comprising at least one radiation-curable composition (I) and at least one pressure-sensitive adhesive (II);
wherein said mixture does not comprise an adhesive which requires an additional compound as a curing agent.

20: A mixture as claimed in claim 19, wherein the adhesive (II) comprises at least one acrylic adhesive.

21: A mixture as claimed in claim 19, wherein the adhesive has a glass transition temperature T_{g} of between −60 and −10° C.

22: A mixture as claimed in claim 19, wherein the adhesive (II) comprises an adhesive composition crosslinkable by active radiant energy.

23: A mixture as claimed in claim 22, wherein the adhesive composition crosslinkable by active irradiation of energy has a glass transition temperature T_{g} of between −60 and +10° C.

24: A mixture as claimed in claim 22, wherein the adhesive composition crosslinkable by active irradiation of energy has a molar weight of between 200 000 and 1 500 000 g/mol.

25: A mixture as claimed in claim 19, wherein the radiation-curable composition (I) comprises
(A) at least one polymerizable compound comprising two or more copolymerizable, ethylenically unsaturated groups,
(B) optionally, reactive diluents,
(C) optionally, photoinitiator, and
(D) optionally at least one coating additive.

26: A mixture as claimed in claim 25, wherein the radiation-curable composition (I) comprises
40-100% by weight of at least one polymerizable compound comprising two or more copolymerizable, ethylenically unsaturated groups (A),
0-60% by weight of reactive diluents (B),
0-20% by weight of photoinitiator (C), and
0-50% by weight of at least one coating additive (D)
wherein (A), (B), (C) and (D) together make up 100% by weight.

27: A mixture as claimed in claim 25, comprising compounds (A) comprising carbonate or urethane (meth)acrylates or carbonate or urethane vinyl ethers.

28: A mixture as claimed in claim 25, comprising at least one polymer-analogously modified copolymer as compound (A).

29: A mixture as claimed in claim 19, comprising
90-99.9% by weight of radiation-curable composition (I) and
0.1-10% by weight of pressure sensitive adhesive (II).

30: A method of coating a substrate which comprises coating a substrate with a coating material comprising the mixture claimed in claim 19, thereby obtaining a coated substrate.

31: A method as claimed in claim 30, further comprising
thermally treating said coated substrate, and
curing said coating material with active radiant energy.

32: A method as claimed in claim 31, wherein said active radiant energy is light of wavelength ranging from 150 to 700 nm.

33: A method as claimed in claim 31, wherein the thermal treatment is carried out at between 40 and 120° C.

34: The method of coating a substrate as claimed in claim 31, wherein said substrate is plastic, glass or metal.

35: The method of coating a substrate as claimed in claim 31, wherein said substrate is metal foil and/or plastic film or a composite of metal foil and plastic film.

36: A mixture comprising at least one radiation-curable composition (I) and at least one pressure-sensitive adhesive (II);
wherein said mixture does not comprise an adhesive which requires an additional compound as a curing agent; and
wherein the adhesive (II) comprises an adhesive composition crosslinkable by active radiant energy.
